(19) United States
(12) Patent Application Publication
(10) Pub. No.: US 2026/0032144 A1
(43) Pub. Date: Jan. 29, 2026

(54) HYBRID CLASSICAL-QUANTUM ADVERSARIAL ENGINE FOR ENHANCING SECURITY OF ARTIFICIAL INTELLIGENCE MODELS

(71) Applicant: Angel Cuenca, Dallas, TX (US)

(72) Inventor: Angel Cuenca, Dallas, TX (US)

(21) Appl. No.: 19/278,456

(22) Filed: Jul. 23, 2025

Related U.S. Application Data
(60) Provisional application No. 63/674,582, filed on Jul. 23, 2024.

(51) Int. Cl. H04L 9/40

(52) U.S. Cl. CPC H04L 63/1433

(57) ABSTRACT

The present disclosure provides a method of facilitating an adversarial testing of an artificial intelligence (AI) model. Further, the method may include retrieving, using a storage device, an initial test data associated with the AI model. Further, the method may include generating, using a processing device, a perturbed test data using a quantum adversarial generator module based on the initial test data. Further, the method may include transmitting, using a communication device, the perturbed test data to a client device associated with a client.

### FIELD OF DISCLOSURE

The present disclosure relates to the field of data processing. More specifically, the present disclosure relates to a hybrid classical-quantum adversarial engine for enhancing security of artificial intelligence models.

### BACKGROUND

The field of artificial intelligence has seen remarkable advancements over recent years, with models being deployed across various domains to enhance decision-making processes. However, as these models become more sophisticated, so too have the methods used to exploit them. Adversarial attacks, which manipulate data samples to cause models to make incorrect predictions, pose a significant threat to the reliability and security of artificial intelligence systems.

In many applications, such as fraud detection, autonomous vehicles, and healthcare diagnostics, the potential consequences of adversarial attacks are severe, leading to financial losses, safety risks, or compromised patient outcomes. As a result, there has been a growing emphasis on developing robust methods to detect and mitigate these attacks. The ability to generate and apply adversarial modifications in ways that evade traditional detection mechanisms remains a critical challenge in ensuring the security and reliability of artificial intelligence models.

AI models deployed in sensitive domains such as finance, healthcare, geospatial analysis, and autonomous systems are increasingly vulnerable to a wide range of adversarial attacks. These include, but are not limited to evasion attacks like subtle manipulation of model inputs to cause misclassification at inference; data poisoning attacks like injection of malicious samples into the training data to degrade or subvert model behavior; backdoor (Trojan) attacks like embedding hidden triggers during training, so models behave incorrectly when the trigger is present; physical-world adversarial attacks like adversarial modifications that remain effective after being applied in real environments (e.g., stickers, audio playback, printed images); transferability attacks like adversarial examples that transfer across models or tasks; model extraction (stealing) attacks like reconstructing a surrogate model by querying the original; model inversion attacks like inferring sensitive training data from model outputs; membership inference attacks like determining if a specific data point was in the training set; model poisoning (parameter-level, e.g., federated learning) like manipulation of model weights or aggregation; adaptive or red-team attacks like iteratively probing, adapting, and refining adversarial strategies; universal adversarial modifications like single adversarial modification fools a wide range of inputs; targeted and untargeted attacks like attacks aiming for specific outputs or any misclassification; clean-label attacks like evasion or poisoning attacks without changing the data label; query-limited/black-box attacks like attacks with restricted model access (e.g., no gradients); semantic or realistic attacks like adversarial manipulations that are interpretable by humans or mimic real-world changes; generative (GAN-based or similar) attacks like use of generative models to craft adversarial modifications; adversarial patch attacks like physical or digital “patch” triggers misclassification; label flipping attacks like changing labels in the training set to poison the model; exploratory/reconnaissance attacks like probing the model to understand its boundaries.

Traditional approaches to adversarial attack generation often rely solely on classical computational methods. While classical methods have proven effective in certain scenarios, they may lack the sophistication needed to create adversarial examples that are undetectable by traditional model defenses. Furthermore, existing systems may struggle with ensuring data sovereignty and security, particularly when sensitive information must be processed or shared across distributed networks.

In this context, there remains a need for improved methods that can overcome the limitations of current systems and protect AI models from adversarial attacks.

Therefore, there is a need for an improved hybrid classical-quantum adversarial engine for enhancing security of artificial intelligence models that may overcome one or more of the above-mentioned problems and/or limitations.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of facilitating an adversarial testing of an artificial intelligence (AI) model. Further, the method may include retrieving, using a storage device, an initial test data associated with the AI model. Further, the method may include generating, using a processing device, a perturbed test data using a quantum adversarial generator module based on the initial test data. Further, the method may include transmitting, using a communication device, the perturbed test data to a client device associated with a client.

The present disclosure provides a method of facilitating an adversarial testing of an artificial intelligence (AI) model. Further, the method may include retrieving, using a storage device, an initial test data associated with the AI model. Further, the method may include analyzing, using a processing device, the initial test data. Further, the method may include obtaining, using the processing device, a workflow specification data representing a workflow specification associated with an adversarial workflow. Further, the method may include identifying, using the processing device, the adversarial workflow from two or more adversarial workflows using an automation module based on the workflow specification. Further, the identifying of the adversarial workflow may be further based on a workflow identification technique. Further, the method may include determining, using the processing device, a strategic adversarial attribute relative to the initial test data using a quantum optimization module based on the analyzing of the initial test data. Further, the strategic adversarial attribute represents a strategic data-point associated with the initial test data. Further, the method may include generating, using the processing device, a perturbed test data using a quantum adversarial generator module based on each of the identifying of the adversarial workflow and the determining of the strategic adversarial attribute. Further, the method may include transmitting, using a communication device, the perturbed test data to a client device associated with a client.

The present disclosure provides a system for facilitating an adversarial testing of an artificial intelligence (AI) model. Further, the system may include a storage device which may be configured for retrieving an initial test data associated with the AI model. Further, the system may include a processing device communicatively coupled with the storage device. Further, the processing device may be configured for generating a perturbed test data using a quantum adversarial generator module based on the initial test data. Further, the system may include a communication device communicatively coupled with the processing device. Further, the communication device may be configured for transmitting the perturbed test data to a client device associated with a client.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 of facilitating an adversarial testing of an artificial intelligence (AI) model, in accordance with some embodiments.

FIG. 4 illustrates a flowchart of a method 400 of facilitating an adversarial testing of an artificial intelligence (AI) model including determining, using the processing device 1304, a strategic adversarial attribute relative to the initial test data using a quantum optimization module, in accordance with some embodiments.

FIG. 5 illustrates a flowchart of a method 500 of facilitating an adversarial testing of an artificial intelligence (AI) model including generating, using the processing device 1304, the initial test data using a classical adversarial generator module, in accordance with some embodiments.

FIG. 6 illustrates a flowchart of a method 600 of facilitating an adversarial testing of an artificial intelligence (AI) model including processing, using the processing device 1304, the intermediary test data using the quantum adversarial generator module, in accordance with some embodiments.

FIG. 7 illustrates a flowchart of a method 700 of facilitating an adversarial testing of an artificial intelligence (AI) model including generating, using the processing device 1304, a second perturbed test data using the quantum adversarial generator module, in accordance with some embodiments.

FIG. 8 illustrates a flowchart of a method 800 of facilitating an adversarial testing of an artificial intelligence (AI) model including generating, using the processing device 1304, an analysis report data, in accordance with some embodiments.

FIG. 9 illustrates a flowchart of a method 900 of facilitating an adversarial testing of an artificial intelligence (AI) model including analyzing, using the processing device 1304, the quantum analysis data, in accordance with some embodiments.

FIG. 10 illustrates a flowchart of a method 1000 of facilitating an adversarial testing of an artificial intelligence (AI) model including generating, using the processing device 1304, a plurality of updated quantum algorithms using the classifier module, in accordance with some embodiments.

FIG. 11 illustrates a flowchart of a method 1100 of facilitating an adversarial testing of an artificial intelligence (AI) model including processing, using the processing device 1304, the client-based test data, in accordance with some embodiments.

FIG. 12 illustrates a flowchart of a method 1200 of facilitating an adversarial testing of an artificial intelligence (AI) model, in accordance with some embodiments.

FIG. 13 illustrates a block diagram of a system 1300 of facilitating an adversarial testing of an artificial intelligence (AI) model, in accordance with some embodiments.

FIG. 14 illustrates a flowchart of a method 1400 of facilitating an adversarial testing of an artificial intelligence (AI) model including analyzing, using the processing device 1304, the AI model parameter data, in accordance with some embodiments.

FIG. 15 illustrates a flowchart of a method 1500 of facilitating an adversarial testing of an artificial intelligence (AI) model including processing, using the processing device 1304, each of the initial test data and the adversarial modification data, in accordance with some embodiments.

FIG. 16 illustrates a flowchart of a method 1600 of facilitating an adversarial testing of an artificial intelligence (AI) model including analyzing, using the processing device 1304, the client input data, in accordance with some embodiments.

FIG. 17 illustrates a flowchart of a methodology for facilitating an adversarial testing of an artificial intelligence (AI) model, in accordance with some embodiments.

FIG. 18 illustrates an artificial intelligence (AI) system architecture for explainable artificial intelligence models, in accordance with some embodiments.

FIG. 19 illustrates an intricate system comprising distinct components intricately interconnected to generate adversarial samples using quantum circuits, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, artificial intelligence may be performed on the historical data in order to determine the one or more predefined conditions. For instance, artificial intelligence on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes a hybrid classical-quantum adversarial engine for enhancing security of artificial intelligence (AI) models. Further, the present disclosure describes methods and systems facilitating an adversarial testing of an artificial intelligence (AI) model.

Further, the present disclosure describes a novel system to protect artificial intelligence models from a variety of types of attacks. Further, the novel system is the disclosed system. Further, the system integrates quantum-generated adversarial modifications with outputs from classical adversarial tools and employs quantum computing to identify the most effective points within these outputs to perturb. Further, the dual approach creates sophisticated adversarial samples that are more challenging for traditional models to detect and defend against, thereby building more secure and reliable AI systems.

In some embodiments, the system utilizes a combination of classical and quantum computing techniques to generate complex adversarial modifications and to pinpoint the most effective adversarial modification points. Further, the system employs classical adversarial tools to produce initial data samples, followed by the use of quantum circuits to introduce subtle, sophisticated adversarial modifications to these samples. Additionally, quantum algorithms analyze these samples to determine the most strategic points for adversarial modification, enhancing the effectiveness of the adversarial examples in fooling artificial intelligence models. Further, an iterative feedback loop is employed where the performance of the model on these adversarial examples informs further refinements, thereby enhancing the model's security.

In some embodiments, the system comprises a classical adversarial tools, a quantum adversarial generator, a quantum optimization module, a quantum refinement module, an integration and feedback mechanism, and a graphical user interface (GUI).
Classical Adversarial Tools: A variety of tools capable of generating initial data samples that serve as the basis for adversarial example generation.
Quantum Perturbation Generator: Contains quantum circuits, which are quantum algorithms that generate adversarial modifications by encoding complex features from the input data.
Quantum Optimization Module: Uses quantum algorithms specifically designed to identify the most effective points for adversarial modification within the data samples.
Quantum Refinement Module: Applies quantum algorithms to further refine or enhance adversarial modifications already applied by classical methods, optimizing the classical adversarial modifications to enhance their effectiveness in deceiving AI models.
Integration and Feedback Mechanism:
   Perturbation Application Module: Combines quantum adversarial modifications with outputs from classical adversarial tools to create adversarial examples.
   Classifier: An artificial intelligence model that evaluates the adversarial examples.
   Feedback Loop: Refines the quantum adversarial modifications and optimization strategies based on the classifier's performance.
Graphical User Interface (GUI): Allows users to selectively apply quantum optimization or classical adversarial modification strategies and to visualize the impacts of these choices on adversarial example effectiveness.

In some embodiments, the present disclosure describes a process or method with the following steps:
1. Gather Initial Data Samples: Collect or select initial data that will serve as the basis for adversarial example generation. This data can come from various sources relevant to the targeted AI models and is intended to be manipulated in subsequent steps.
2. Choose Optimization Approach: Users decide on the sequence of optimization based on model complexity, resource availability, and specific security needs. Options include:
   Quantum Optimization First: Utilize quantum algorithms initially to identify the most effective points for adversarial modification, ensuring that the adversarial modifications are precisely targeted.
   Classical Perturbations First: Apply classical adversarial modifications directly to the initial data, using tools designed to modify the data samples effectively.
3. Apply Perturbations:
   For Quantum Optimization First:
      a. Quantum Circuits (Perturbation Generator): Apply quantum algorithms to generate adversarial modifications directly following the quantum optimization.
      b. Perturbation Application Module: Integrate these quantum-generated adversarial modifications into the initial data samples.
   For Classical Perturbations First:
      a. Apply Initial Perturbations: Utilize the classical adversarial tools to modify the initial data directly.
      b. Quantum Refinement Module: Further refine the perturbed samples using quantum techniques to enhance their effectiveness.
4. Create Adversarial Examples: Combine the perturbed data samples—with enhancements from either quantum or classical methods—with the original data to produce sophisticated adversarial examples.
5. Evaluate Adversarial Examples: Feed these examples into the classifier and observe its performance.
6. Iterative Refinement: Use the feedback from the classifier to continuously refine the adversarial modification strategies and their application. Adjustments may involve tweaking quantum algorithms, refining classical adversarial techniques, or both, depending on the initial approach chosen. The system dynamically adjusts strategies based on real-time feedback, continuously enhancing the security effectiveness of generated adversarial samples.

In some embodiments, the present disclosure describes a method for optimizing adversarial examples using quantum computing techniques that identify the most effective points for adversarial modification within data samples before applying any adversarial modifications. Further, the present disclosure covers the use of quantum algorithms to conduct initial analysis and optimization of data for adversarial purposes.

In some embodiments, the present disclosure describes a system for refining adversarial examples generated by classical adversarial tools using quantum computing techniques to enhance their effectiveness in deceiving AI models. Further, the present disclosure includes the application of quantum algorithms to further refine or enhance adversarial modifications already applied by classical methods.

In some embodiments, the present disclosure describes a hybrid system that integrates quantum and classical computing techniques to generate and refine adversarial examples, where the system allows for sequential application of these techniques to optimize adversarial outputs for artificial intelligence model testing.

In some embodiments, the present disclosure describes a method for using feedback from a classifier to iteratively refine quantum and classical adversarial modification strategies within a hybrid adversarial example generation system. Further, the present disclosure would cover the adaptive feedback mechanisms that utilize classifier responses to dynamically adjust both quantum and classical adversarial modification processes.

In some embodiments, the present disclosure describes a graphical user interface configured to allow users to selectively apply quantum optimization or classical adversarial modification strategies and to visualize the impacts of these choices on adversarial example effectiveness. Further, the present disclosure emphasizes the user interaction component, which facilitates the operational flexibility of choosing and monitoring adversarial modification strategies.

In some embodiments, the present disclosure describes a system for enhancing security of artificial intelligence models, the system comprising:
Classical adversarial tools are configured to generate initial data samples.
A quantum adversarial generator comprising quantum circuits configured to apply adversarial modifications to the data samples.
A quantum optimization module is configured to identify the most effective points for adversarial modifications within the data samples using quantum algorithms.
A quantum refinement module is configured to further refine or enhance adversarial modifications already applied by classical methods.
An adversarial modification application module is configured to integrate the adversarial modifications from the quantum adversarial generator at the identified points within the data samples to produce adversarial examples.
A classifier is configured to evaluate the adversarial examples and provide feedback to refine the operations of the quantum adversarial generator and the quantum optimization module.
A graphical user interface (GUI) is configured to allow users to selectively apply quantum optimization or classical adversarial modification strategies and to visualize the impacts of these choices on adversarial example effectiveness.

In some embodiments, the present disclosure describes a method for generating adversarial examples to train artificial intelligence models, the method comprising:
Generating initial data samples using classical adversarial tools.
Encoding complex features from the initial data samples using quantum circuits.
Identifying effective adversarial modification points within the encoded features using a quantum optimization module.
Applying quantum-generated adversarial modifications at the identified effective points to the data samples using a quantum adversarial generator.
Creating adversarial examples by integrating the perturbed data samples.
Evaluating the adversarial examples using a classifier to determine the effectiveness of the adversarial modifications.
Utilizing feedback from the classifier to continuously refine the adversarial modification strategies and their application.

In some embodiments, the present disclosure relates generally to artificial intelligence security. More specifically, it relates to a modular, user-configurable, and enterprise-integrated hybrid classical-quantum adversarial engine, a system and method for generating, refining, and automating adversarial modifications and queries for a broad spectrum of artificial intelligence attack scenarios, including those yet to be discovered. Further, the system supports both a graphical user interface (GUI) and an application programming interface (API) for workflow management, output integration, and enterprise security.

In some embodiments, the present disclosure describes a hybrid classical-quantum adversarial engine comprising:

### 1. User Interface (GUI/API)

For configuring, managing, and monitoring all workflow stages, including:
   a. Selection, ordering, and number of classical and quantum adversarial generation, query, or refinement steps (any order and any combination).
   b. Feature selection strategy for each step.
   c. Quantum hardware/cloud provider selection.
   d. Output/integration with enterprise security tools.

### 2. Adversarial Generation, Query, and Refinement Modules

Means for generating adversarial modifications and query strategies using any sequence or combination of classical and/or quantum algorithms (including but not limited to: classical-classical, quantum-quantum, classical-quantum, quantum-classical, quantum-only, classical-only, hybrid/iterative, etc.).
The engine may operate in user-configurable, pre-configured, fixed, or automatically selected order/number of steps.

### 3. Workflow Engine With Automation

Allows the user, administrator, or automated policy/module to define or select the workflow pipeline:
   a. Any number, order, and combination of classical and quantum steps.
   b. The automation module may select, configure, or adapt the adversarial workflow based on any combination of: model type or architecture, data modality, input dimensionality, model complexity, transparency, historical attack effectiveness, performance/resource constraints, compliance or policy requirements, user preferences, or any other relevant operational or security considerations.
   c. The automation module may employ rule-based logic, optimization algorithms, or artificial intelligence techniques to determine the most effective adversarial pipeline for a given task.

### 4. Feature Selection and Refinement (With Clarification)

Clarification of Feature Selection:
   In the context of the present disclosure, feature selection refers specifically to the process of identifying which input features (such as variables, pixels, audio bins, or structured data fields) should be targeted for refinement or further adversarial optimization by subsequent steps in the adversarial modification or query generation workflow.
a. After each adversarial generation or refinement step (whether classical or quantum), the engine analyzes the current perturbed input to determine which features most strongly influence the model's output, vulnerability, or response to attack. The engine then selects a subset of these features—using techniques such as gradient analysis, saliency maps, model explainability methods (e.g., SHAP, LIME), statistical analysis, randomization, or adaptive/feedback-driven approaches—for focused refinement by the next module (classical or quantum) in the pipeline.
b. This is distinct from traditional feature selection for model training or dimensionality reduction; here, feature selection is an integral part of an iterative adversarial attack or query workflow to maximize the effectiveness and stealth of adversarial strategies while optimizing computational efficiency.
Feature selection is applied in any workflow configuration (classical-classical, quantum-quantum, classical-quantum, quantum-classical, hybrid/iterative, etc.), and is dynamically tailored to the model, data, and adversarial pipeline stage. The selected features guide focused refinement or optimization by the next adversarial module.
In some embodiments, the engine may refine all features at each step without explicit feature selection; both approaches are supported.

### 5. Quantum Hardware Provider Selection

User/system can select among IBM Quantum, Google Quantum AI, IonQ, Rigetti, Quantinuum, Amazon Braket, D-Wave, Pasqal, or any compatible present or future provider.

### 6. Output and Integration

Results—including refined adversarial modifications, queries, robustness scores, audit logs, and alerts are provided for enhancing the security and privacy assessment of AI models and may be transmitted to third-party systems (SIEM, GRC, AIOps, etc.) via secure APIs, webhooks, or file exports.

In some embodiments, the engine is algorithm-agnostic and supports the integration, configuration, and use of any present or future classical, quantum, or hybrid adversarial generation, query, or refinement method, in any order or combination. Further, feature selection/refinement strategies are applied flexibly at each step, according to workflow, model, and data. Further, the GUI/API provides for user, admin, policy-driven, or automated workflow configuration.

Further, the modular workflow, feature selection, query generation, and automation capabilities of the adversarial engine are applicable to a wide variety of attack types, including but not limited to: evasion attacks, data poisoning attacks, backdoor (Trojan) attacks, physical-world adversarial attacks, transferability attacks, model extraction (stealing) attacks, model inversion attacks, membership inference attacks, model poisoning at the parameter level (including federated/distributed learning), adaptive/red-teaming attacks, universal adversarial modifications, targeted and untargeted attacks, clean-label attacks, query-limited/black-box attacks, semantic or realistic attacks, generative (GAN-based or similar) attacks, adversarial patch attacks, label flipping attacks, and exploratory/reconnaissance attacks.

Further, the engine may be configured to generate, refine, or optimize queries and adversarial modifications for use in security auditing, red-teaming, privacy assessment, or defense enhancement for any of these attack vectors.

In some embodiments, the present disclosure describes the following real-world use cases for the system:

### 1. Financial Services—Securing AI-Powered Loan Approval Models

Financial institutions use artificial intelligence models to automate loan approvals. Such models are high-value targets for adversaries seeking to commit fraud by subtly altering input data (such as income or employment status) to receive unauthorized loan approval. Data poisoning is also a risk, where attackers corrupt training data to bias or weaken the model.
The hybrid engine allows security analysts to simulate sophisticated adversarial attacks for model auditing and retraining. A typical workflow involves generating a baseline adversarial modification using a classical method (e.g., PGD) across all features. Next, the most sensitive features are identified using explainability techniques (such as SHAP values, which quantify input influence). These features are passed to a quantum refinement step (e.g., QAOA) to optimize the adversarial modification for stealth and effectiveness, uncovering previously missed vulnerabilities and producing data for robust adversarial training.

```
High-level pseudocode -
  x_adv = classical_attack (model, x_orig, method= ‘PGD’,
  feature_selection= ‘gradient’)
  selected_features = select_features (model, x_adv, method= ‘SHAP’)
  x_adv_refined = quantum_refine (x_adv, method= ‘QAOA’,
  features= selected_features)
```

### 2. Geospatial Analysis—Hardening Satellite Image Classifiers

Satellite and aerial imagery models are used in sectors such as agriculture, environmental monitoring, disaster response, and urban planning. These models can be vulnerable to subtle, coordinated changes in image data—whether due to adversarial manipulation or naturally occurring phenomena—that may lead to misclassification or detection failure.
The adversarial engine enables analysts to discover vulnerabilities in large, high-dimensional image datasets. The process begins with a quantum algorithm (e.g., QAOA) that efficiently explores combinations of image pixels or regions most likely to influence the model's classification or detection outcome. Saliency analysis identifies areas of highest impact. A classical adversarial algorithm (e.g., DeepFool) then refines the adversarial modification on these regions for realism and subtlety. This approach reveals weaknesses, supports robust retraining, and helps ensure the reliability of geospatial AI in diverse scenarios.

```
High-level pseudocode -
  x_adv = quantum_attack (model, x_orig, method= ‘QAOA’,
  feature_selection= ‘saliency’)
  selected_pixels = select_features (model, x_adv, method= ‘statistical’)
  x_adv_refined = classical_refine (model, s_adv, method=
  ‘DeepFool’, features= selected_pixels)
```

### 3. Autonomous Vehicles—Robustness Testing of Perception AI

Self-driving cars rely on perception systems to identify road signs, obstacles, and pedestrians. An adversary could use small physical modifications (e.g., stickers on a stop sign) or subtle changes in sensor data to fool the model into misclassifying critical objects, with safety consequences.
The engine enables iterative, adaptive robustness testing. The process starts by generating a first adversarial modification (e.g., using a classical FGSM attack) targeting features identified as most influential via gradient analysis. After each round, the model's new vulnerabilities are reassessed using adaptive feature selection. The workflow alternates between classical and quantum optimization steps (e.g., quantum walks) to progressively find combinations of feature changes that maximize the likelihood of real-world attack success. This approach mimics a determined attacker and reveals multi-stage weaknesses for mitigation and retraining.

```
High-level pseudocode -
  x_adv = x_orig
  for i in range (num_iterations):
    features_classical = select_features (model, x_adv, method=
    ‘gradient’)
    x_adv = classical_attack (model, x_adv, method= ‘FGSM’,
  feature_selection= features_classical)
    features_quantum = select_features (model, x_adv, method=
    ‘adaptive’)
    x_adv = quantum_refine (x_adv, method= ‘quantum_walks',
  features= features_quantum)
```

### 4. Audio Automatic Speech Recognition (ASR)-Detecting Imperceptible Audio Attacks

ASR models are widely used in call centers, voice authentication, and digital assistants. Adversaries may craft audio signals with subtle adversarial modifications that are imperceptible to humans but cause the model to misinterpret commands or speech.
The hybrid engine lets defenders simulate advanced audio attacks. It may first use a quantum algorithm (e.g., QAOA) with random feature selection to explore the large space of possible audio adversarial modifications, especially in time-frequency bins. The most impactful bins, identified via saliency analysis, are then targeted by a classical attack method (e.g., JSMA) to further increase attack success while keeping changes imperceptible. The resulting adversarial samples can be used to evaluate, retrain, and certify ASR models.

```
High-level pseudocode -
  x_adv = quantum_attack (model, x_orig, method= ‘QAOA’,
  feature_selection= ‘random’)
  selected_bins = select_features (model, x_adv, method= ‘saliency’)
  s_adv = classical_refine (model, x_adv, method= ‘JSMA’, features=
  selected_bins)
```

In some embodiments, the present disclosure describes a system for generating adversarial modifications and/or queries for an artificial intelligence model. Further, the system comprises:
A graphical user interface (GUI) or application programming interface (API) for configuring, managing, or monitoring a workflow comprising any sequence and combination of classical and/or quantum adversarial generation, query, or refinement algorithms, wherein the workflow order, type, and number of steps are user-configurable, pre-configured, fixed, or determined automatically by an automation module.
A means for selecting a candidate subset of input features for each workflow step, or for applying each step to all features, based on at least one of: gradient analysis, saliency map analysis, model explainability, statistical analysis, randomization, adaptive/feedback-driven selection, quantum-native search, or any other suitable method.
A means for outputting results, including refined adversarial modifications, queries, robustness scores, or audit information, and for integrating with third-party systems, including security information and event management (SIEM) platforms, governance/risk/compliance (GRC) systems, or model management/AIOps tools.
An automation module configured to select, configure, or adapt the workflow based on any combination of: model type, data modality, model complexity, input dimensionality, transparency, historical attack performance, resource constraints, compliance or policy requirements, user preferences, or any other relevant criteria.
Further, the system is algorithm-agnostic and supports any order or combination of classical and/or quantum steps, and does not require any specific quantum or classical artificial intelligence model or architecture, and is applicable to evasion, data poisoning, backdoor, physical-world, transferability, model extraction, model inversion, membership inference, model poisoning, adaptive/red-team, universal, targeted, untargeted, clean-label, query-limited, semantic, generative, patch, label flipping, and exploratory attacks.

Further, the workflow comprises at least one classical and one quantum adversarial generation or refinement algorithm.

Further, the adversarial workflow is selected automatically by an automation module based on at least one of: model type, data modality, input dimensionality, model complexity, transparency, historical attack performance, resource constraints, compliance requirements, or user preferences.

Further, feature selection is performed before or after each adversarial step, using gradient analysis, saliency maps, model explainability, statistical analysis, randomization, or adaptive/feedback-driven selection.

Further, wherein the quantum hardware provider is selected from a group comprising IBM Quantum, Google Quantum AI, IonQ, Rigetti, Quantinuum, Amazon Braket, D-Wave, Pasqal, or any compatible present or future provider.

Further, wherein output is transmitted to SIEM, GRC, or AIOps systems via secure API, webhook, or file export.

Further, wherein the modular workflow is applicable to at least evasion, data poisoning, backdoor, physical-world, transferability, model extraction, model inversion, membership inference, model poisoning, adaptive/red-team, universal, targeted, untargeted, clean-label, query-limited, semantic, generative, patch, label flipping, and exploratory attacks.

Further, in some embodiments, the hybrid classical-quantum adversarial engine provides a comprehensive, future-proof, and enterprise-ready solution for adversarial robustness and privacy testing in AI models. By supporting any order, type, or number of classical and quantum workflows with granular user configuration, robust automation, advanced feature selection, seamless enterprise integration, and detailed real-world use cases, the system adapts to any current or future AI and quantum security landscape, and delivers strong protection and auditing capability against a broad spectrum of adversarial threats.

In some embodiments, the system further comprises a deployment configuration wherein the adversarial engine is installed within a secure, on-premises computing environment. This configuration enables an organization to run adversarial testing workflows against internal artificial intelligence (AI) models without transmitting sensitive data or model components outside the local network.

In some embodiments, the system includes:
A locally deployed adversarial engine, configured to operate on one or more AI models within the client's internal infrastructure. This engine is capable of initiating adversarial test cases, performing classical adversarial modification generation, and executing local evaluation or refinement workflows.
A quantum agent module, deployed within the same secure environment, is configured to interface with a quantum processing unit (QPU) for quantum-enhanced operations. The quantum agent is capable of:
   Accepting abstracted, non-sensitive input representations derived from internal AI models or specified attack objectives;
   Preparing quantum-compatible payloads and routing them to a designated quantum processing resource;
   Receiving and post-processing quantum outputs for downstream use within the adversarial engine.

Further, in some embodiments, the system supports at least two operational workflows:
A classical-first workflow, wherein the adversarial engine first performs local classical analysis on the target AI model, generates candidate adversarial modifications, and optionally refines or optimizes those adversarial modifications through quantum processing.
A quantum-first workflow, wherein the quantum agent initiates a quantum search or generation procedure based on a specified objective, and the adversarial engine subsequently refines or evaluates the results using full access to the internal model.

In some embodiments, the quantum agent is configured to transmit payloads to a remote, cloud-hosted quantum processing backend via encrypted communication protocols. In an alternative embodiment, the quantum agent is configured to interface directly with a quantum processor located within the client's premises, allowing all classical and quantum processing to occur entirely within the client's secure environment without requiring any outbound network communication.

Further, in some embodiments, model weights, training data, inference inputs, and other sensitive assets remain entirely within the client's control and are not transmitted beyond the local deployment boundary. The quantum agent enforces strict payload abstraction, ensuring that only pre-specified, non-reversible input representations are used in any quantum computation, whether remote or local.

In some embodiments, the quantum agent module may dynamically adapt its adversarial modification generation strategy based on the specific data context or model characteristics. This improvement ensures that the module can handle diverse data types and models with varying levels of robustness, thereby enhancing the effectiveness of adversarial examples across different domains.

Further, the module may incorporate a feature that isolates sensitive data within the local network, ensuring that no potentially harmful information is transmitted outside the system. This improvement addresses concerns around data sovereignty and security, particularly in industries with strict regulatory requirements.

In some implementations, the quantum agent module may facilitate seamless integration of classical adversarial tools with quantum processing units, allowing for a hybrid approach where both classical and quantum adversarial modification strategies are employed simultaneously. This dual-processing method ensures that adversarial examples are more challenging to detect by traditional models.

Further, the quantum agent module may utilize an iterative feedback mechanism that allows for real-time adjustment of adversarial modification strategies based on the performance of the classifier. This improvement enables the system to continuously enhance its effectiveness against adversarial attacks, thereby improving overall model security and reliability.

In some embodiments, the quantum agent module may employ advanced adversarial modification generation techniques that leverage quantum circuits for creating more sophisticated and harder-to-detect adversarial examples. This improvement builds upon recent developments in quantum computing, allowing for the generation of adversarial modifications that are highly effective in compromising artificial intelligence models.

Further, the quantum agent module may be extended to integrate with recent artificial intelligence techniques, such as reinforcement learning, to refine the generation of adversarial examples based on dynamic model behavior. This improvement allows for a more adaptive approach to adversarial modification generation, ensuring that adversarial attacks remain effective even as models evolve.

In some embodiments, quantum error correction techniques may be incorporated into the module to enhance the reliability and accuracy of quantum processing operations. This improvement ensures that the module can handle complex computations without significant errors, thereby improving the overall effectiveness of adversarial example generation.

Further, the module may be augmented with advanced adversarial detection mechanisms that employ artificial intelligence techniques to identify and neutralize potential threats more effectively. This improvement adds an additional layer of security by making it harder for adversaries to bypass the system's defenses.

In some embodiments, a zero-trust architecture may be implemented within the module to ensure that all data and computations remain securely isolated. This improvement addresses critical security concerns by ensuring that no component or process within the system can access sensitive information unless authorized explicitly.

Further, the quantum agent module may be enhanced with explainable AI frameworks that provide insights into how adversarial modifications affect artificial intelligence models. This improvement allows users to better understand the impact of their actions and makes it easier to debug or adjust strategies as needed. Further, the adversarial modifications may include perturbations.

In some embodiments, the system may use reinforcement learning algorithms to dynamically select the most efficient sequence of adversarial tests. Further, the system may employ neural networks trained on historical test data to predict the optimal testing order for new inputs. Further, the system may also include automated selection of attack vectors based on model performance metrics and gradients. Further, the system may leverage quantum-inspired optimization algorithms to minimize the computational resources required for adversarial testing.

In some embodiments, the system may use quantum-based communication channels to transmit performance metrics in real time. Further, the system may incorporate quantum sensors to monitor model behavior and provide immediate feedback on adversarial inputs. Further, the system may also include quantum-computed decision trees that analyze test results as they are generated, enabling near-instantaneous adjustments to testing protocols.

In some embodiments, the system may leverage quantum annealing algorithms to optimize model parameters based on real-time performance data.

In some embodiments, the system may use quantum-based feature extraction algorithms to identify relevant patterns across multiple data sources. Further, the system may employ quantum neural networks that can process multimodal data while maintaining the encapsulation of sensitive information. Further, the system may also include secure multi-party computation protocols that enable collaborative data fusion without exposing individual datasets.

In some embodiments, the system may leverage quantum entanglement to distribute computational tasks across multiple nodes, enabling efficient fusion of data from distributed sources.

In some embodiments, the system may use homomorphic encryption techniques that allow data to be processed in encrypted form without decrypting it. Further, the system may incorporate secure multi-party computation protocols where data is shared between parties without exposing individual information. Further, the system may also include quantum-safe cryptographic algorithms that provide enhanced security for communication channels.

In some implementations, the system may leverage quantum key distribution (QKD) to establish secure communication keys for data exchange.

In some embodiments, the system may use quantum-inspired anomaly detection algorithms that continuously monitor for new types of adversarial patterns. Further, the system may incorporate adaptive defense systems that reconfigure based on real-time analysis of model behavior and input patterns. Further, the system may also include automated threat intelligence feeds that provide updates on emerging attack methods, enabling the system to adjust its defense mechanisms accordingly.

In some embodiments, the system may leverage quantum-computed adversarial indices that predict potential vulnerabilities in complex models.

In some embodiments, the system may use active learning algorithms that systematically test models against diverse datasets to identify potential vulnerabilities. Further, the system may incorporate quantum-computed gradient descent methods that provide insights into model sensitivity and resilience to adversarial inputs. Further, the system may also include automated retraining protocols that update models based on findings from adversarial testing.

In some embodiments, the system may leverage quantum-inspired regularization techniques that reduce overfitting and improve generalization performance.

In some embodiments, the system may use quantum-based regulatory checklists that automatically verify compliance with relevant data protection standards. Further, the system may incorporate quantum sensors that monitor data handling practices in real time, flagging potential compliance issues. Further, the system may also include automated remediation tools that suggest changes to reduce compliance risks without compromising encapsulation.

In some implementations, the system may leverage quantum-computed risk assessments that prioritize compliance requirements based on organizational policies and regulatory frameworks.

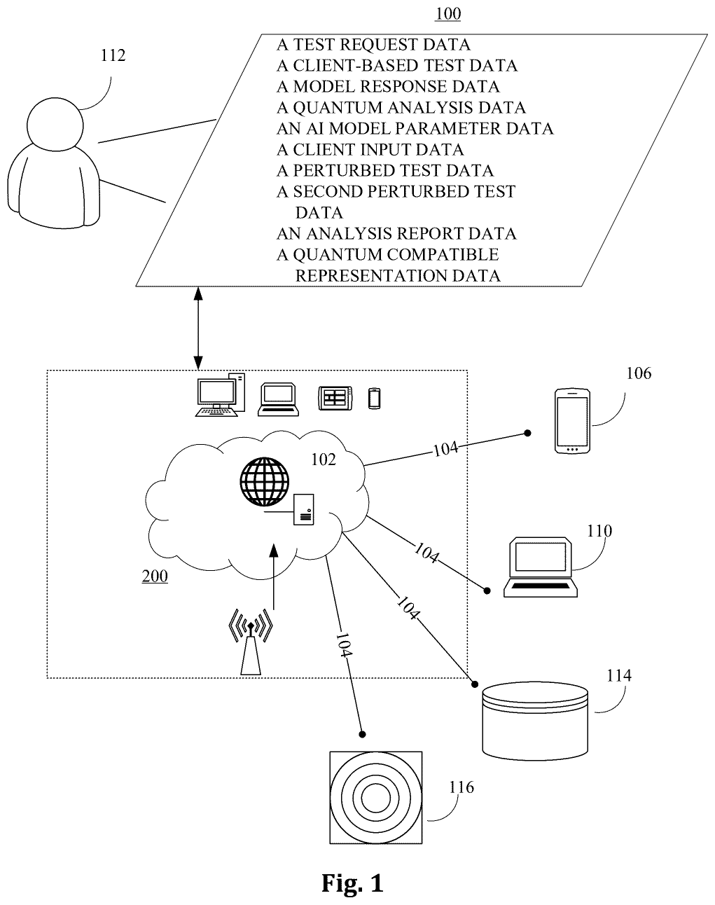

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

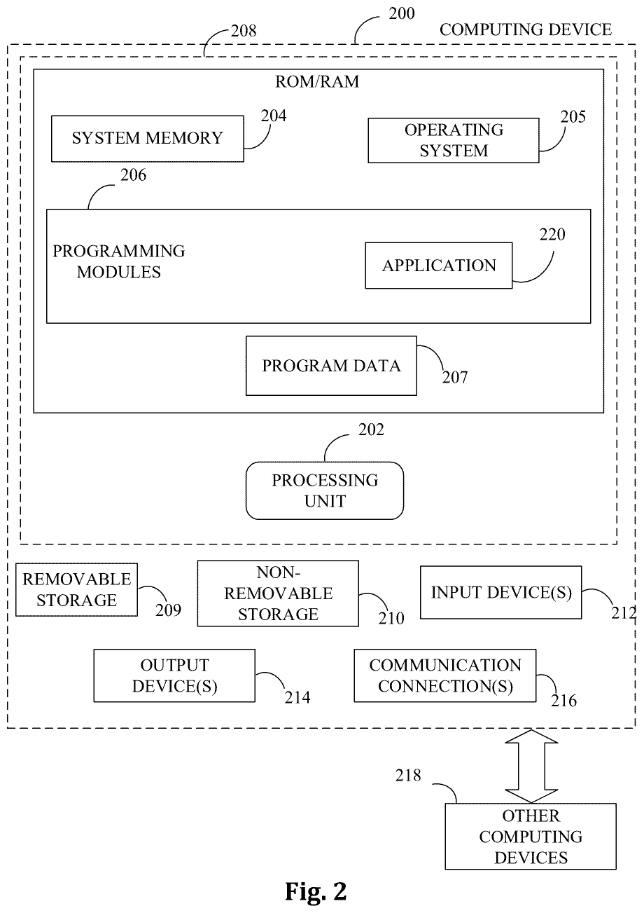

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, artificial intelligence module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include artificial intelligence applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

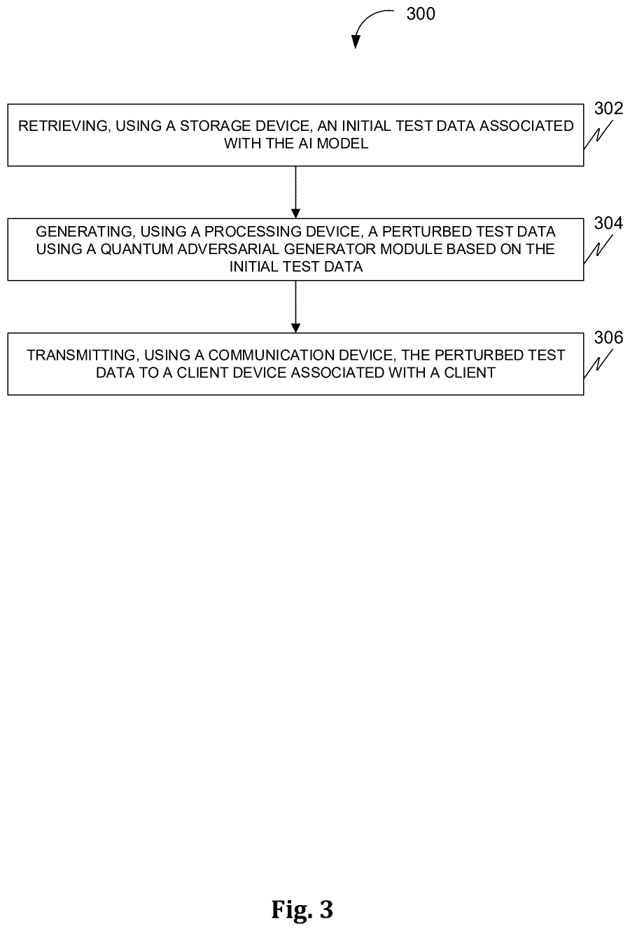

FIG. 3 illustrates a flowchart of a method 300 of facilitating an adversarial testing of an artificial intelligence (AI) model, in accordance with some embodiments.

Accordingly, the method 300 may include a step 302 of retrieving, using a storage device 1302, an initial test data associated with the AI model. Further, the method 300 may include a step 304 of generating, using a processing device 1304, a perturbed test data using a quantum adversarial generator module based on the initial test data. Further, the method 300 may include a step 306 of transmitting, using a communication device 1306, the perturbed test data to a client device 1308 associated with a client.

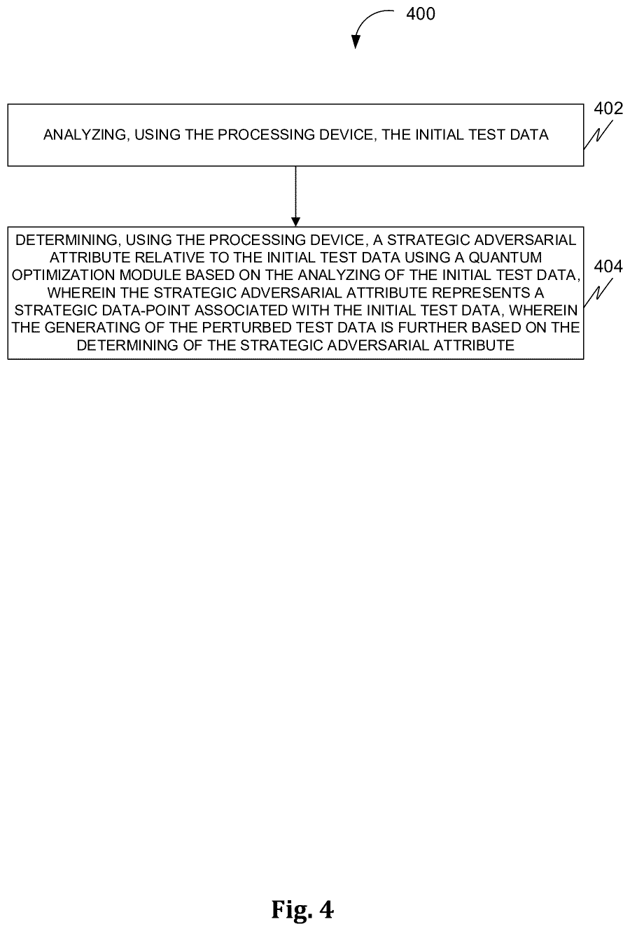

FIG. 4 illustrates a flowchart of a method 400 of facilitating an adversarial testing of an artificial intelligence (AI) model including determining, using the processing device 1304, a strategic adversarial attribute relative to the initial test data using a quantum optimization module, in accordance with some embodiments.

Further, in some embodiments, the method 400 further may include a step 402 of analyzing, using the processing device 1304, the initial test data. Further, in some embodiments, the method 400 further may include a step 404 of determining, using the processing device 1304, a strategic adversarial attribute relative to the initial test data using a quantum optimization module based on the analyzing of the initial test data. Further, the strategic adversarial attribute represents a strategic data-point associated with the initial test data. Further, the generating of the perturbed test data may be further based on the determining of the strategic adversarial attribute.

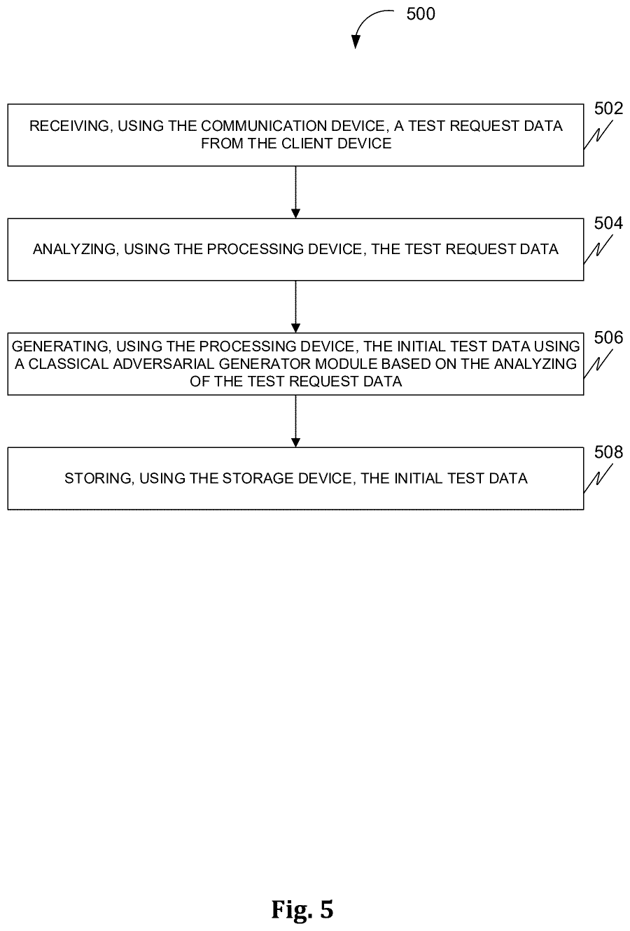

FIG. 5 illustrates a flowchart of a method 500 of facilitating an adversarial testing of an artificial intelligence (AI) model including generating, using the processing device 1304, the initial test data using a classical adversarial generator module, in accordance with some embodiments.

Further, in some embodiments, the method 500 further may include a step 502 of receiving, using the communication device 1306, a test request data from the client device. Further, in some embodiments, the method 500 further may include a step 504 of analyzing, using the processing device 1304, the test request data. Further, in some embodiments, the method 500 further may include a step 506 of generating, using the processing device 1304, the initial test data using a classical adversarial generator module based on the analyzing of the test request data. Further, in some embodiments, the method 500 further may include a step 508 of storing, using the storage device 1302, the initial test data.

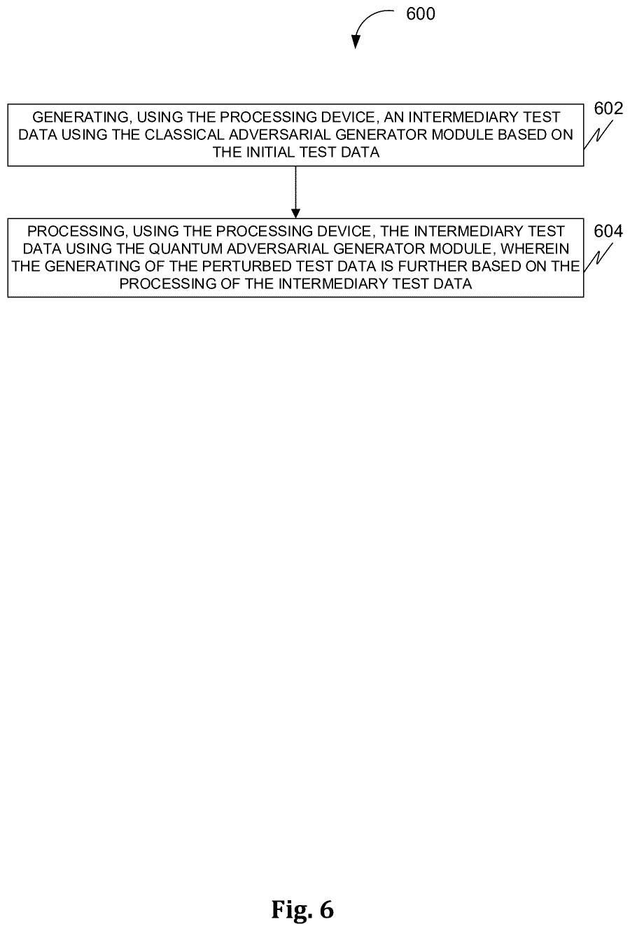

FIG. 6 illustrates a flowchart of a method 600 of facilitating an adversarial testing of an artificial intelligence (AI) model including processing, using the processing device 1304, the intermediary test data using the quantum adversarial generator module, in accordance with some embodiments.

Further, in some embodiments, the method 600 further may include a step 602 of generating, using the processing device 1304, an intermediary test data using the classical adversarial generator module based on the initial test data. Further, in some embodiments, the method 600 further may include a step 604 of processing, using the processing device 1304, the intermediary test data using the quantum adversarial generator module. Further, the generating of the perturbed test data may be further based on the processing of the intermediary test data.

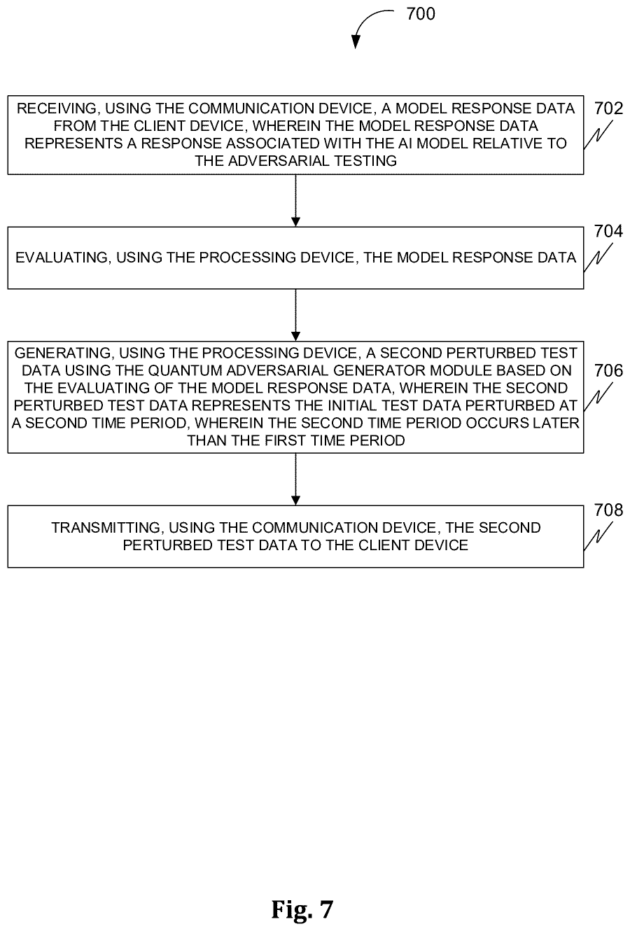

FIG. 7 illustrates a flowchart of a method 700 of facilitating an adversarial testing of an artificial intelligence (AI) model including generating, using the processing device 1304, a second perturbed test data using the quantum adversarial generator module, in accordance with some embodiments.

Further, in some embodiments, the generating of the perturbed test data may be associated with a first time period. Further, the method 700 further may include a step 702 of receiving, using the communication device 1306, a model response data from the client device. Further, the model response data represents a response associated with the AI model relative to the adversarial testing. Further, the method 700 further may include a step 704 of evaluating, using the processing device 1304, the model response data. Further, the method 700 further may include a step 706 of generating, using the processing device 1304, a second perturbed test data using the quantum adversarial generator module based on the evaluating of the model response data. Further, the second perturbed test data represents the initial test data perturbed at a second time period. Further, the second time period occurs later than the first time period. Further, the method 700 further may include a step 708 of transmitting, using the communication device 1306, the second perturbed test data to the client device.

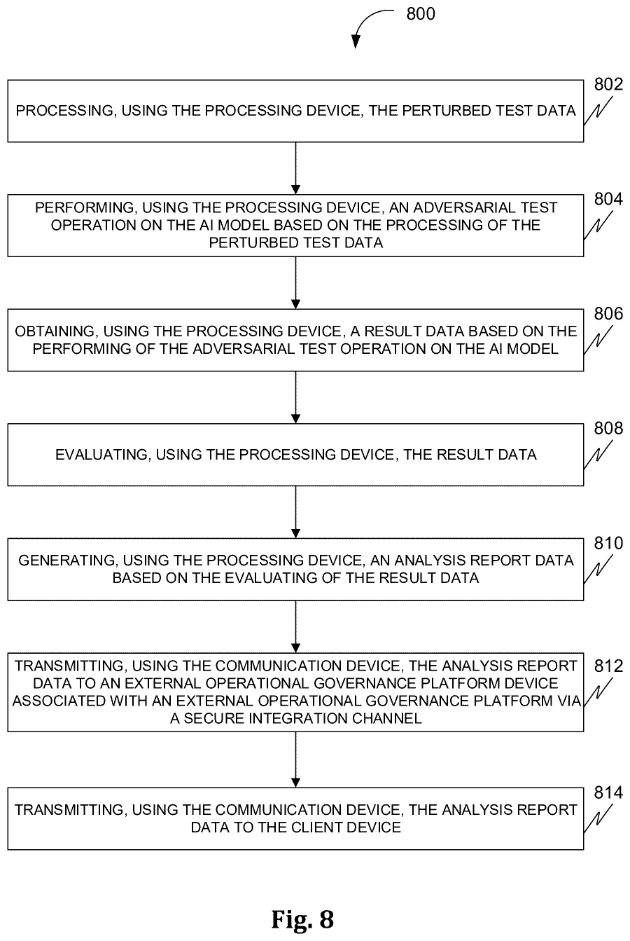

FIG. 8 illustrates a flowchart of a method 800 of facilitating an adversarial testing of an artificial intelligence (AI) model including generating, using the processing device 1304, an analysis report data, in accordance with some embodiments.

Further, in some embodiments, the method 800 further may include a step 802 of processing, using the processing device 1304, the perturbed test data. Further, in some embodiments, the method 800 further may include a step 804 of performing, using the processing device 1304, an adversarial test operation on the AI model based on the processing of the perturbed test data. Further, in some embodiments, the method 800 further may include a step 806 of obtaining, using the processing device 1304, a result data based on the performing of the adversarial test operation on the AI model. Further, in some embodiments, the method 800 further may include a step 808 of evaluating, using the processing device 1304, the result data. Further, in some embodiments, the method 800 further may include a step 810 of generating, using the processing device 1304, an analysis report data based on the evaluating of the result data. Further, in some embodiments, the method 800 further may include a step 812 of transmitting, using the communication device 1306, the analysis report data to an external operational governance platform device associated with an external operational governance platform via a secure integration channel. Further, in some embodiments, the method 800 further may include a step 814 of transmitting, using the communication device 1306, the analysis report data to the client device.

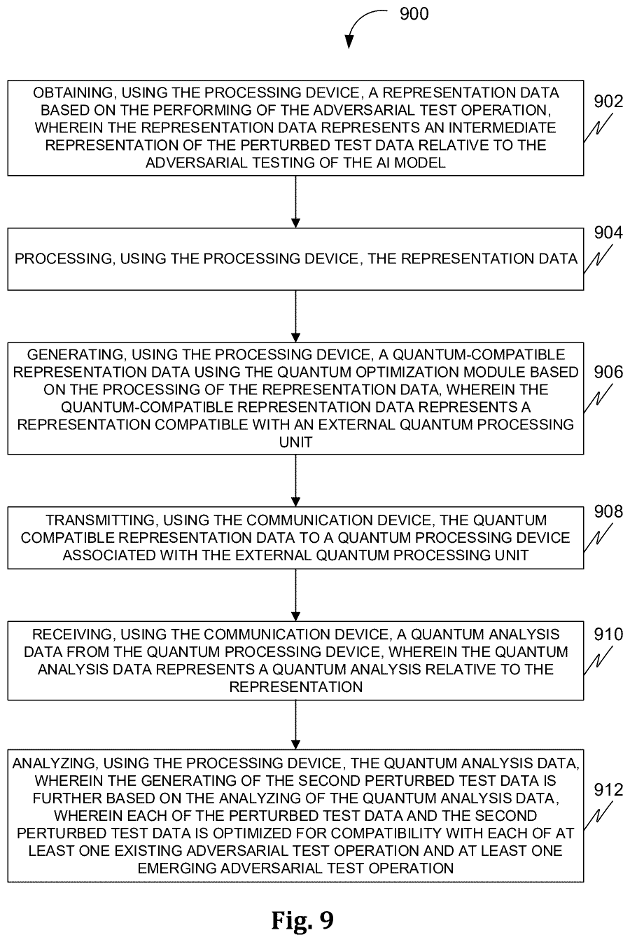

FIG. 9 illustrates a flowchart of a method 900 of facilitating an adversarial testing of an artificial intelligence (AI) model including analyzing, using the processing device 1304, the quantum analysis data, in accordance with some embodiments.

Further, in some embodiments, the method 900 further may include a step 902 of obtaining, using the processing device 1304, a representation data based on the performing of the adversarial test operation. Further, the representation data represents an intermediate representation of the perturbed test data relative to the adversarial testing of the AI model. Further, in some embodiments, the method 900 further may include a step 904 of processing, using the processing device 1304, the representation data. Further, in some embodiments, the method 900 further may include a step 906 of generating, using the processing device 1304, a quantum-compatible representation data using the quantum optimization module based on the processing of the representation data. Further, the quantum-compatible representation data represents a representation compatible with an external quantum processing unit. Further, in some embodiments, the method 900 further may include a step 908 of transmitting, using the communication device 1306, the quantum compatible representation data to a quantum processing device associated with the external quantum processing unit. Further, in some embodiments, the method 900 further may include a step 910 of receiving, using the communication device 1306, a quantum analysis data from the quantum processing device. Further, the quantum analysis data represents a quantum analysis relative to the representation. Further, in some embodiments, the method 900 further may include a step 912 of analyzing, using the processing device 1304, the quantum analysis data. Further, the generating of the second perturbed test data may be further based on the analyzing of the quantum analysis data. Further, each of the perturbed test data and the second perturbed test data may be optimized for compatibility with each of one or more existing adversarial test operations and one or more emerging adversarial test operations.

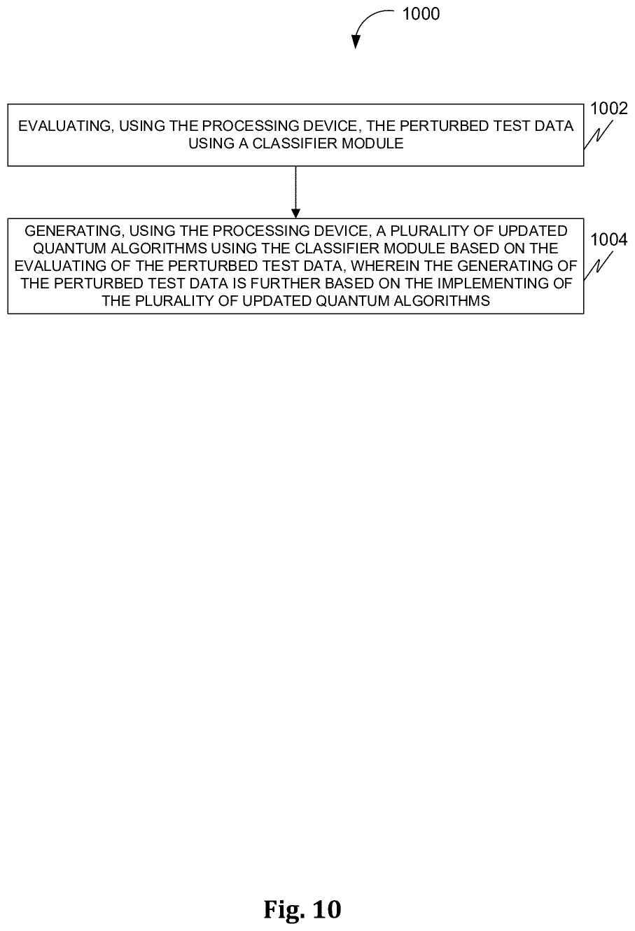

FIG. 10 illustrates a flowchart of a method 1000 of facilitating an adversarial testing of an artificial intelligence (AI) model including generating, using the processing device 1304, a plurality of updated quantum algorithms using the classifier module, in accordance with some embodiments.

Further, in some embodiments, the quantum adversarial generator module may be configured for implementing two or more quantum algorithms. Further, the generating of the perturbed test data may be further based on the implementing of the two or more quantum algorithms. Further, the method 1000 further may include a step 1002 of evaluating, using the processing device 1304, the perturbed test data using a classifier module. Further, the quantum adversarial generator module may be configured for implementing two or more quantum algorithms. Further, the method 1000 further may include a step 1004 of generating, using the processing device 1304, two or more updated quantum algorithms using the classifier module based on the evaluating of the perturbed test data. Further, the generating of the perturbed test data may be further based on the implementing of the two or more updated quantum algorithms.

In some embodiments, the classical adversarial generator module may be configured for implementing two or more classical algorithms. Further, the generating of the intermediary test data may be further based on the implementing of the two or more classical algorithms. Further, the method 1000 further includes generating, using the processing device 1304, two or more updated classical algorithms using the classifier module based on the evaluating of the perturbed test data. Further, the generating of the intermediary test data may be further based on the implementing of the two or more updated classical algorithms.

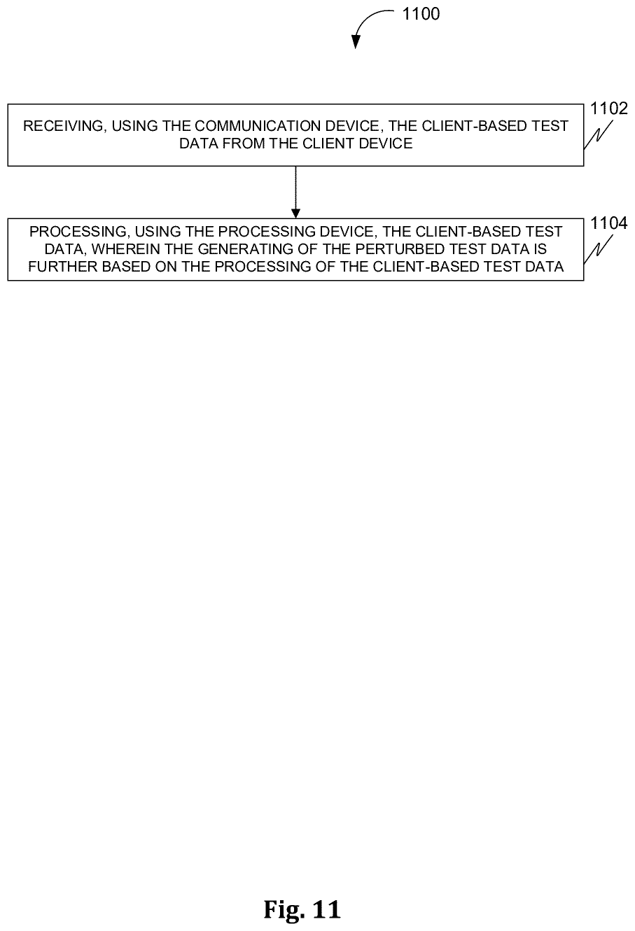

FIG. 11 illustrates a flowchart of a method 1100 of facilitating an adversarial testing of an artificial intelligence (AI) model including processing, using the processing device 1304, the client-based test data, in accordance with some embodiments.

Further, in some embodiments, the method 1100 further may include a step 1102 of receiving, using the communication device 1306, the client-based test data from the client device. Further, in some embodiments, the method 1100 further may include a step 1104 of processing, using the processing device 1304, the client-based test data. Further, the generating of the perturbed test data may be further based on the processing of the client-based test data.

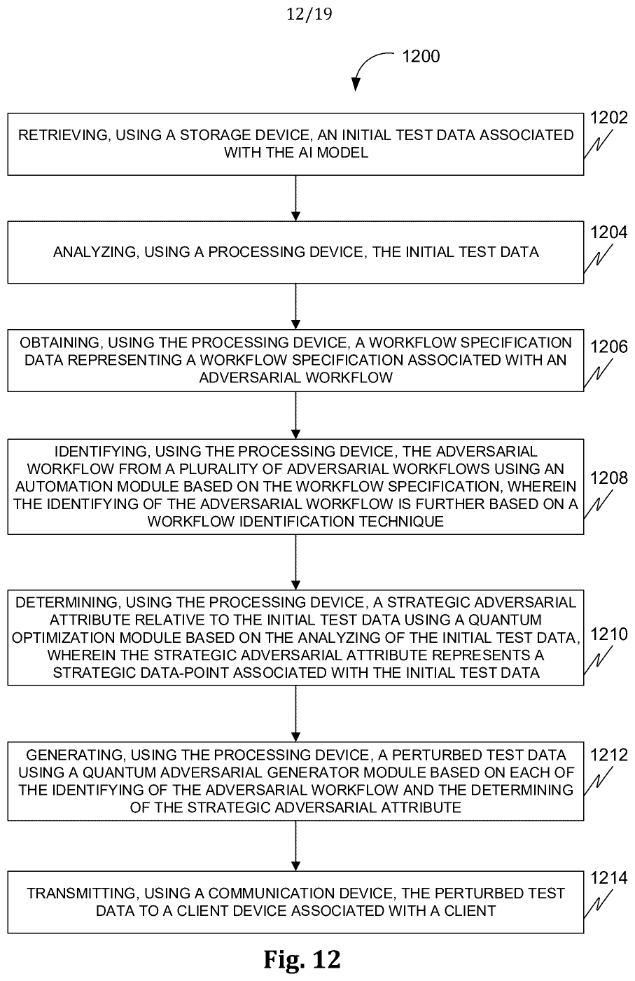

FIG. 12 illustrates a flowchart of a method 1200 of facilitating an adversarial testing of an artificial intelligence (AI) model, in accordance with some embodiments.

Accordingly, the method 1200 may include a step 1202 of retrieving, using a storage device 1302, an initial test data associated with the AI model. Further, the method 1200 may include a step 1204 of analyzing, using a processing device 1304, the initial test data. Further, the method 1200 may include a step 1206 of obtaining, using the processing device 1304, a workflow specification data representing a workflow specification associated with an adversarial workflow. Further, the method 1200 may include a step 1208 of identifying, using the processing device 1304, the adversarial workflow from two or more adversarial workflows using an automation module based on the workflow specification. Further, the identifying of the adversarial workflow may be further based on a workflow identification technique. Further, the method 1200 may include a step 1210 of determining, using the processing device 1304, a strategic adversarial attribute relative to the initial test data using a quantum optimization module based on the analyzing of the initial test data. Further, the strategic adversarial attribute represents a strategic data-point associated with the initial test data. Further, the method 1200 may include a step 1212 of generating, using the processing device 1304, a perturbed test data using a quantum adversarial generator module based on each of the identifying of the adversarial workflow and the determining of the strategic adversarial attribute. Further, the method 1200 may include a step 1214 of transmitting, using a communication device 1306, the perturbed test data to a client device 1308 associated with a client.

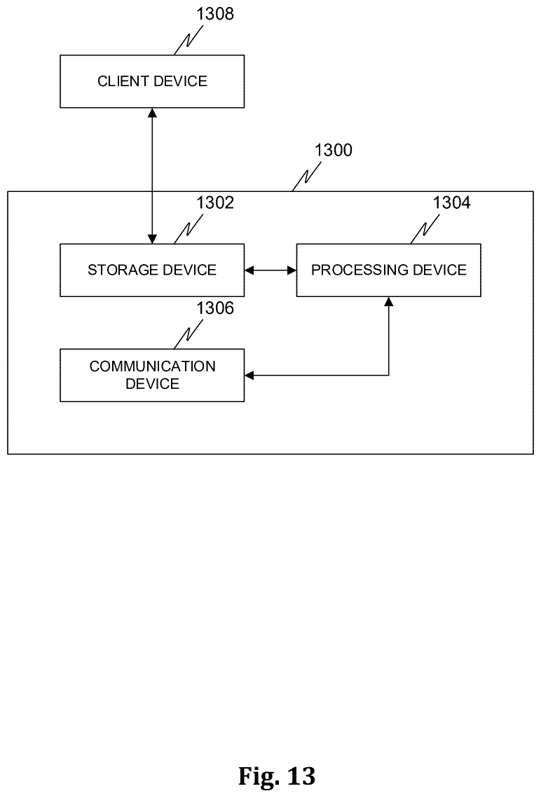

FIG. 13 illustrates a block diagram of a system 1300 of facilitating an adversarial testing of an artificial intelligence (AI) model, in accordance with some embodiments.

Accordingly, the system 1300 may include a storage device 1302 which may be configured for retrieving an initial test data associated with the AI model. Further, the system 1300 may include a processing device 1304 communicatively coupled with the storage device 1302. Further, the processing device 1304 may be configured for generating a perturbed test data using a quantum adversarial generator module based on the initial test data. Further, the system 1300 may include a communication device 1306 communicatively coupled with the processing device 1304. Further, the communication device 1306 may be configured for transmitting the perturbed test data to a client device 1308 associated with a client.

Further, in some embodiments, the processing device 1304 may be further configured for analyzing the initial test data. Further, the processing device 1304 may be further configured for determining a strategic adversarial attribute relative to the initial test data using a quantum optimization module based on the analyzing of the initial test data. Further, the strategic adversarial attribute represents a strategic data-point associated with the initial test data. Further, the generating of the perturbed test data may be further based on the determining of the strategic adversarial attribute.

Further, in some embodiments, the communication device 1306 may be further configured for receiving a test request data from the client device 1308. Further, the processing device 1304 may be further configured for analyzing the test request data. Further, the processing device 1304 may be further configured for generating the initial test data using a classical adversarial generator module based on the analyzing of the test request data. Further, the storage device 1302 may be further configured for storing the initial test data.

Further, in some embodiments, the processing device 1304 may be further configured for generating an intermediary test data using the classical adversarial generator module based on the initial test data. Further, the processing device 1304 may be further configured for processing the intermediary test data using the quantum adversarial generator module. Further, the generating of the perturbed test data may be further based on the processing of the intermediary test data.

Further, in some embodiments, the generating of the perturbed test data may be associated with a first time period. Further, the communication device 1306 may be further configured for receiving a model response data from the client device 1308. Further, the model response data represents a response associated with the AI model relative to the adversarial testing. Further, the communication device 1306 may be further configured for transmitting a second perturbed test data to the client device 1308. Further, the processing device 1304 may be further configured for evaluating the model response data. Further, the processing device 1304 may be further configured for generating the second perturbed test data using the quantum adversarial generator module based on the evaluating of the model response data. Further, the second perturbed test data represents the initial test data perturbed at a second time period. Further, the second time period occurs later than the first time period.

Further, in some embodiments, the processing device 1304 may be further configured for processing the perturbed test data. Further, the processing device 1304 may be further configured for performing an adversarial test operation on the AI model based on the processing of the perturbed test data. Further, the processing device 1304 may be further configured for obtaining a result data based on the performing of the adversarial test operation on the AI model. Further, the processing device 1304 may be further configured for evaluating the result data. Further, the processing device 1304 may be further configured for generating an analysis report data based on the evaluating of the result data. Further, the communication device 1306 may be further configured for transmitting the analysis report data to an external operational governance platform device associated with an external operational governance platform via a secure integration channel. Further, the communication device 1306 may be further configured for transmitting the analysis report data to the client device 1308.

Further, in some embodiments, the processing device 1304 may be further configured for obtaining a representation data based on the performing of the adversarial test operation. Further, the representation data represents an intermediate representation of the perturbed test data relative to the adversarial testing of the AI model. Further, the processing device 1304 may be further configured for processing the representation data. Further, the processing device 1304 may be further configured for generating a quantum-compatible representation data using the quantum optimization module based on the processing of the representation data. Further, the quantum-compatible representation data represents a representation compatible with an external quantum processing unit. Further, the processing device 1304 may be further configured for analyzing a quantum analysis data. Further, the generating of the second perturbed test data may be further based on the analyzing of the quantum analysis data. Further, each of the perturbed test data and the second perturbed test data may be optimized for compatibility with each of one or more existing adversarial test operations and one or more emerging adversarial test operations. Further, the communication device 1306 may be further configured for transmitting the quantum compatible representation data to a quantum processing device associated with the external quantum processing unit. Further, the communication device 1306 may be further configured for receiving the quantum analysis data from the quantum processing device. Further, the quantum analysis data represents a quantum analysis relative to the representation.

Further, in some embodiments, the quantum adversarial generator module may be configured for implementing two or more quantum algorithms. Further, the generating of the perturbed test data may be further based on the implementing of the two or more quantum algorithms. Further, the processing device 1304 may be further configured for evaluating the perturbed test data using a classifier module. Further, the quantum adversarial generator module may be configured for implementing two or more quantum algorithms. Further, the processing device 1304 may be further configured for generating two or more updated quantum algorithms using the classifier module based on the evaluating of the perturbed test data. Further, the generating of the perturbed test data may be further based on the implementing of the two or more updated quantum algorithms.

In some embodiments, the classical adversarial generator module may be configured for implementing two or more classical algorithms. Further, the generating of the intermediary test data may be further based on the implementing of the two or more classical algorithms. Further, the processing device 1304 may be further configured for generating two or more updated classical algorithms using the classifier module based on the evaluating of the perturbed test data. Further, the generating of the intermediary test data may be further based on the implementing of the two or more updated classical algorithms.

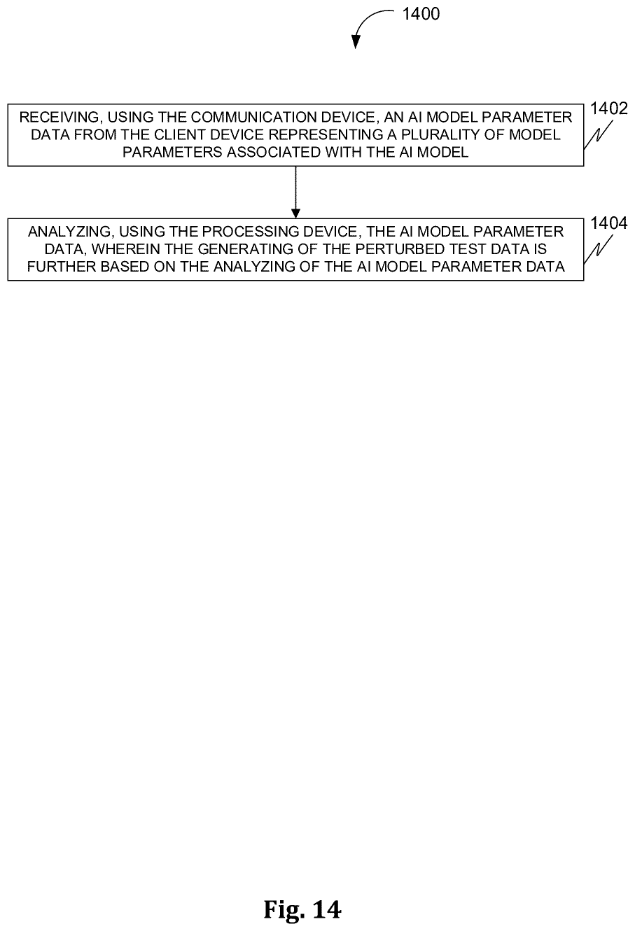

FIG. 14 illustrates a flowchart of a method 1400 of facilitating an adversarial testing 1304, the AI model parameter data, in accordance with some embodiments.

Further, in some embodiments, the method 1400 further may include a step 1402 of receiving, using the communication device 1306, an AI model parameter data from the client device representing two or more model parameters associated with the AI model. Further, in some embodiments, the method 1400 further may include a step 1404 of analyzing, using the processing device 1304, the AI model parameter data. Further, the generating of the perturbed test data may be further based on the analyzing of the AI model parameter data.

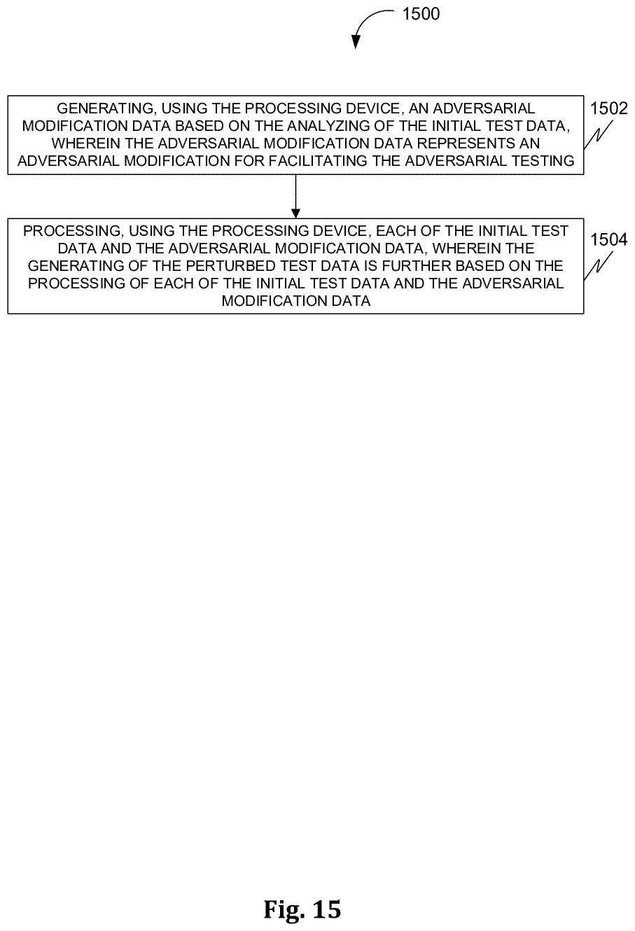

FIG. 15 illustrates a flowchart of a method 1500 of facilitating an adversarial testing of an artificial intelligence (AI) model including processing, using the processing device 1304, each of the initial test data and the adversarial modification data, in accordance with some embodiments.

Further, in some embodiments, the method 1500 further may include a step 1502 of generating, using the processing device 1304, an adversarial modification data based on the analyzing of the initial test data. Further, the adversarial modification data represents an adversarial modification for facilitating the adversarial testing. Further, in some embodiments, the method 1500 further may include a step 1504 of processing, using the processing device 1304, each of the initial test data and the adversarial modification data. Further, the generating of the perturbed test data may be further based on the processing of each of the initial test data and the adversarial modification data.

In some embodiments, the perturbed test data includes a GUI data representing a GUI. Further, the client device includes a client side presentation device which may be configured for presenting the GUI. Further, the client device further includes a client side input device which may be configured for generating a client input data representing an input from the client in relation to the perturbed test data. Further, the client device further includes a client side communication device which may be configured for transmitting the client input data to the communication device 1306.

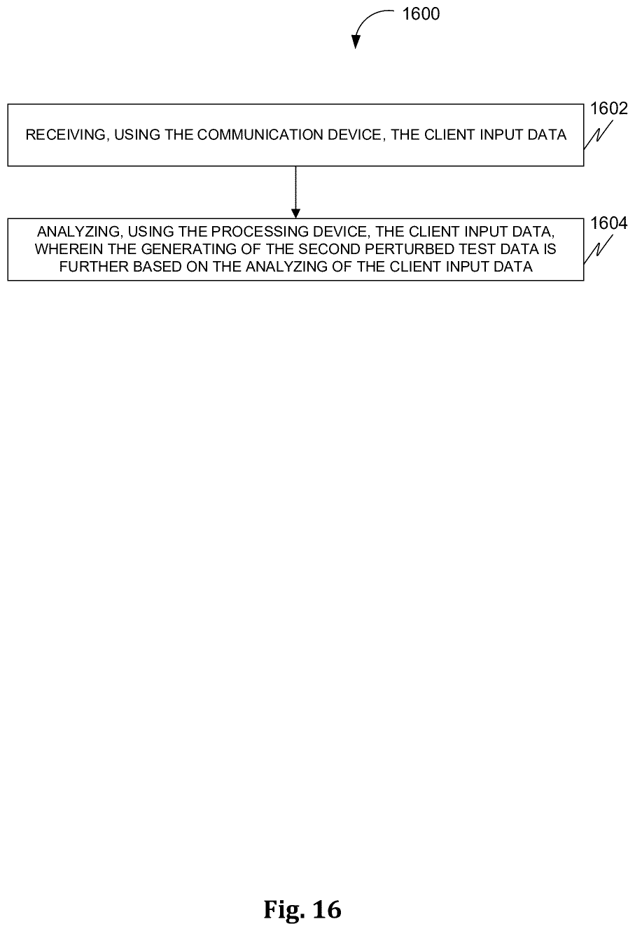

FIG. 16 illustrates a flowchart of a method 1600 of facilitating an adversarial testing of an artificial intelligence (AI) model including analyzing, using the processing device 1304, the client input data, in accordance with some embodiments.

Further, in some embodiments, the method 1600 further may include a step 1602 of receiving, using the communication device 1306, the client input data. Further, in some embodiments, the method 1600 further may include a step 1604 of analyzing, using the processing device 1304, the client input data. Further, the generating of the second perturbed test data may be further based on the analyzing of the client input data.

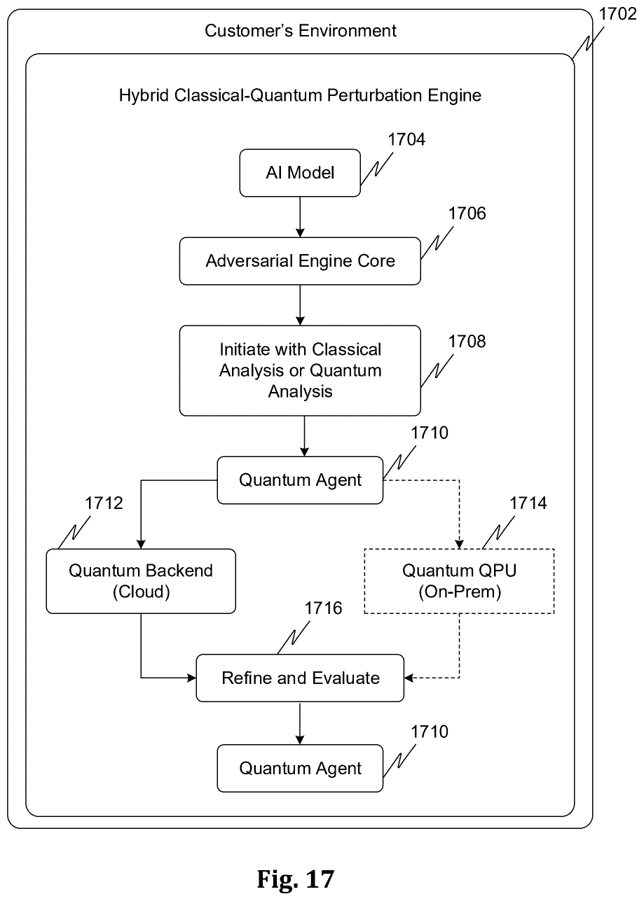

FIG. 17 illustrates a flowchart of a methodology for facilitating an adversarial testing of an artificial intelligence (AI) model, in accordance with some embodiments.

Accordingly, FIG. 17 illustrates a Hybrid Classical-Quantum Perturbation Engine system 1702 comprising an initial component designated as the AI Model 1704, which serves as the starting point for analysis within this environment. Further, the AI model interacts with an integrated Adversarial Engine Core 1706 to initiate either classical or quantum analysis 1708 based on user inputs or specified tasks, thereby activating a dual-path process. Further, one path involves the Quantum Agent 1710 performing Quantum Analysis in conjunction with Cloud resources 1712, while the other path enables direct Quantum Analysis utilizing on premise QPU (Quantum Processing Unit) 1714 capabilities of the Quantum Agent. Further, both pathways converge at a common point where they are perturbed for further refinement. Further, the output from both analysis paths is then subjected to joint refinement and evaluation 1716. Further, a feedback loop mechanism ensures continuous improvement or adaptation based on performance metrics, thereby reinforcing the interrelationship between these components in achieving enhanced analysis capabilities within customer environments through a harmonious blend of classical computation and quantum computing.

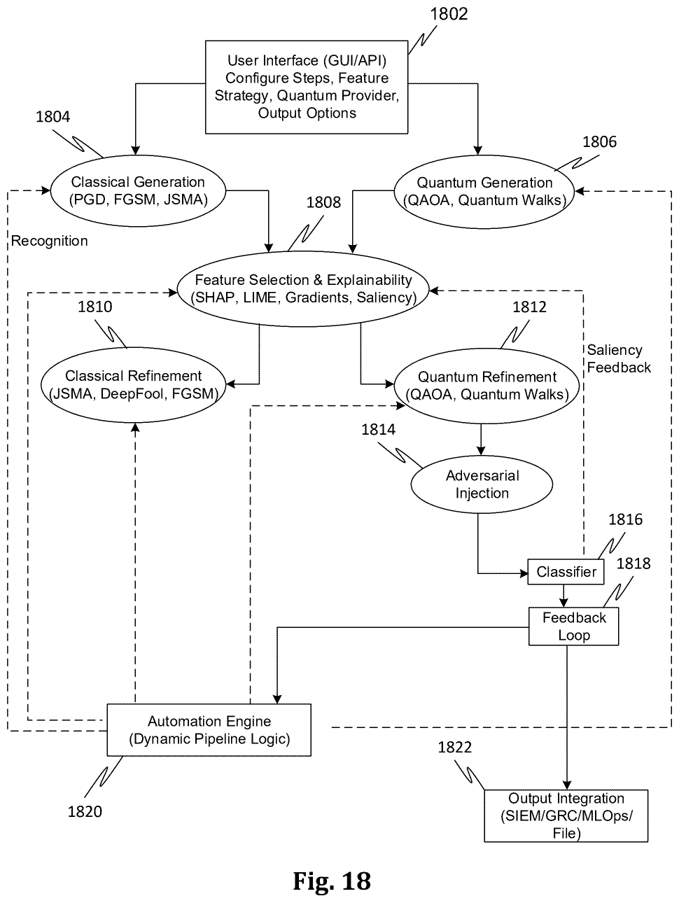

FIG. 18 illustrates an artificial intelligence (AI) system architecture for explainable artificial intelligence models, in accordance with some embodiments.

Accordingly, FIG. 18 presents a comprehensive framework that integrates classical artificial intelligence techniques with quantum AI methods within an explainable AI framework. Further, the user interface 1802 constitutes the starting point of user interaction, featuring GUI/API functionality to configure steps such as feature strategy, quantum provider, and output options. Further, classical generation components 1804, including PGD, FGSM, and JSMA, are utilized for classical artificial intelligence processes. Further, the outputs are then passed through recognition, a classification step in the classical artificial intelligence process. Further, a feature selection & explainability module 1808 incorporates methods like SHAP, LIME, Gradient Descent Explainer (GDE), and Salience Maps to select relevant features and provide explanations on decision-making processes. Further, classical refinement components 1810, comprising JSMA, DeepFool, and FGSM, further refine models using classical techniques. Further, quantum refinement 1812 utilizes quantum refinement methods such as QAOA and Quantum Walks to optimize model performance. Further, adversarial injection 1814 introduces robustness testing by incorporating adversarial examples into the system. Further, the automation engine 1820 dynamically integrates outputs from both classical and quantum refinement processes, while output integration 1822 combines outputs with various components such as SIEM/GRC/AIOps/File systems for further processing or analysis. Further, a continuous feedback loop 1818 is established to refine the model based on user interactions, classification results, and saliency maps, demonstrating a comprehensive integration of explainability, robustness testing, and automated output processing within the AI system architecture.

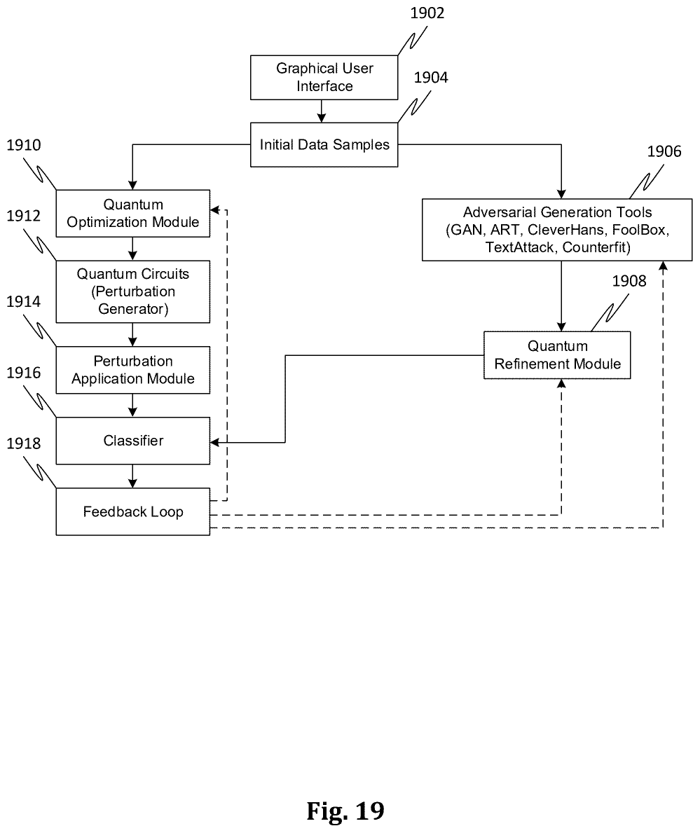

FIG. 19 illustrates an intricate system comprising distinct components intricately interconnected to generate adversarial samples using quantum circuits, in accordance with some embodiments.

Accordingly, the Graphical User Interface 1902 facilitates user interaction by accepting input data samples 1904 and configuring parameters via a user interface. Further, these initial data samples are subsequently processed within the algorithmic process flow and fed into the quantum optimization module 1910. Further, the quantum optimization module may leverage techniques such as Grover's algorithm or Quantum annealing to optimize quantum circuits generated from adversarial generators known as Quantum Circuits (Perturbation Generator) 1912. Further, the optimized quantum circuits are then refined by the Quantum Refinement Module 1908, utilizing additional techniques like TextAttack and Counterfit. Further, these refined quantum circuits are subsequently utilized by the Adversarial Generation Tools 1906, which provide various methods for generating sophisticated adversarial examples, including GANs, ART, CleverHans, FoolBox, TextAttack, and Counterfit. Further, the generated adversarial samples are then evaluated by the Classifier 1916 to determine their effectiveness in testing artificial intelligence models against attacks. Further, a continuous feedback loop 1918 is established between the components, with classifier output used to refine and optimize quantum circuits for improved generation of adversarial examples, thereby enhancing the robustness of artificial intelligence systems against such attacks. Further, the given complex interplay of components enables a sophisticated system capable of generating adversarial samples using quantum computing techniques, ultimately strengthening the security measures of artificial intelligence models, particularly classifiers 1918.

In some embodiments, the method 400 further includes encoding, using the processing device 1304, the strategic adversarial attribute. Further, the generating of the perturbed test data may be further based on the encoding.

In some embodiments, the client input data includes an adversarial modification refinement data representing the input from the client relative to a refinement of the perturbed test data.

In some embodiments, the quantum adversarial generator module includes a quantum refinement module which may be configured for facilitating the generating of the second perturbed test data.

In some embodiments, each of the transmitting and the receiving may be based on an encrypted communication protocol.

In some embodiments, the representation includes one or more of a pre-specified representation and a non-reversible representation associated with the perturbed test data.

In some embodiments, the AI model includes two or more AI models. Further, the performing of the test operation may be further in relation to each of the two or more AI models.

In some embodiments, the test data includes one or more of an image data for an image input, an audio data for an audio input, and a textual data for a textual input. Further, the strategic adversarial attribute relative to the test data includes one or more of a pixel information relative to the image data, an audio bin relative to the audio data, and a structured data field relative to textual data.

In some embodiments, the external quantum processing unit includes two or more external quantum processing units. Further, the client input data includes a quantum processing unit selection data representing the input from the client relative to a selection associated with the two or more external quantum processing units.

In some embodiments, the two or more external quantum processing units include one or more of a IBM Quantum, Google Quantum AI, IonQ, Rigetti, Quantinuum, Amazon Braket, D-Wave, and Pasqal.

In some embodiments, the quantum compatible representation data includes an API call data representing a request to an API associated with the external quantum processing unit.

In some embodiments, the workflow identification technique includes one or more of a rule-based logic, an optimization algorithm, and an artificial intelligence technique.

In some embodiments, the method 1200 may further include analyzing, using the processing device 1304, the workflow specification data. Further, the determining of the adversarial workflow may be further based on the analyzing of the workflow specification data.

In some embodiments, the specification includes one or more of a model type, a model architecture, a data modality, an input dimensionality, a model complexity, a transparency, a historical attack effectiveness, a policy requirement, a client preference, an operational consideration, and a security consideration associated with the adversarial workflow.

In some embodiments, the method 1000 may further include generating, using the processing device 1304, one or more of an audit log data, a robustness score data, and an alert data based on the analyzing of the evaluation result data. Further, the audit log data represents an audit log associated with the adversarial test operation. Further, the robustness score data represents a robustness score for the adversarial test operation. Further, the alert data represents an alert associated with the adversarial test operation. Further, each of the audit log data, the robustness score data, and the alert data may be comprised in the analysis report data.

In some embodiments, the secure integration channel includes one or more of a secure application programming interface based channel, a webhook based channel, and a file export mechanism based channel.

In some embodiments, the external operational governance platform includes one or more of SIEM, GRC, and AIOps.

Although the invention has been explained in relation to its preferred embodiment, it is to be understood that many other possible modifications and variations can be made without departing from the spirit and scope of the invention as hereinafter claimed.

What is claimed is:

1. A method of facilitating an adversarial testing of an artificial intelligence (AI) model, the method comprising:
retrieving, using a storage device, an initial test data associated with the AI model;
generating, using a processing device, a perturbed test data using a quantum adversarial generator module based on the initial test data; and
transmitting, using a communication device, the perturbed test data to a client device associated with a client.

2. The method of claim 1 further comprising:
analyzing, using the processing device, the initial test data; and
determining, using the processing device, a strategic adversarial attribute relative to the initial test data using a quantum optimization module based on the analyzing of the initial test data, wherein the strategic adversarial attribute represents a strategic data-point associated with the initial test data, wherein the generating of the perturbed test data is further based on the determining of the strategic adversarial attribute.

3. The method of claim 1 further comprising:
receiving, using the communication device, a test request data from the client device;
analyzing, using the processing device, the test request data;
generating, using the processing device, the initial test data using a classical adversarial generator module based on the analyzing of the test request data; and
storing, using the storage device, the initial test data.

4. The method of claim 3 further comprising:
generating, using the processing device, an intermediary test data using the classical adversarial generator module based on the initial test data; and
processing, using the processing device, the intermediary test data using the quantum adversarial generator module, wherein the generating of the perturbed test data is further based on the processing of the intermediary test data.

5. The method of claim 2, wherein the generating of the perturbed test data is associated with a first time period, wherein the method further comprising:
receiving, using the communication device, a model response data from the client device, wherein the model response data represents a response associated with the AI model relative to the adversarial testing;
evaluating, using the processing device, the model response data;
generating, using the processing device, a second perturbed test data using the quantum adversarial generator module based on the evaluating of the model response data, wherein the second perturbed test data represents the initial test data perturbed at a second time period, wherein the second time period occurs later than the first time period; and
transmitting, using the communication device, the second perturbed test data to the client device.

6. The method of claim 5 further comprising:
processing, using the processing device, the perturbed test data;
performing, using the processing device, an adversarial test operation on the AI model based on the processing of the perturbed test data;
obtaining, using the processing device, a result data based on the performing of the adversarial test operation on the AI model;
evaluating, using the processing device, the result data;
generating, using the processing device, an analysis report data based on the evaluating of the result data;
transmitting, using the communication device, the analysis report data to an external operational governance platform device associated with an external operational governance platform via a secure integration channel; and
transmitting, using the communication device, the analysis report data to the client device.

7. The method of claim 6 further comprising:
obtaining, using the processing device, a representation data based on the performing of the adversarial test operation, wherein the representation data represents an intermediate representation of the perturbed test data relative to the adversarial testing of the AI model;
processing, using the processing device, the representation data;
generating, using the processing device, a quantum-compatible representation data using the quantum optimization module based on the processing of the representation data, wherein the quantum-compatible representation data represents a representation compatible with an external quantum processing unit;
transmitting, using the communication device, the quantum compatible representation data to a quantum processing device associated with the external quantum processing unit;
receiving, using the communication device, a quantum analysis data from the quantum processing device, wherein the quantum analysis data represents a quantum analysis relative to the representation; and
analyzing, using the processing device, the quantum analysis data, wherein the generating of the second perturbed test data is further based on the analyzing of the quantum analysis data, wherein each of the perturbed test data and the second perturbed test data is optimized for compatibility with each of at least one existing adversarial test operation and at least one emerging adversarial test operation.

8. The method of claim 4, wherein the quantum adversarial generator module is configured for implementing a plurality of quantum algorithms wherein the generating of the perturbed test data is further based on the implementing of the plurality of quantum algorithms, wherein the method further comprises:
evaluating, using the processing device, the perturbed test data using a classifier module; and
generating, using the processing device, a plurality of updated quantum algorithms using the classifier module based on the evaluating of the perturbed test data, wherein the generating of the perturbed test data is further based on the implementing of the plurality of updated quantum algorithms.

9. The method of claim 8, wherein the classical adversarial generator module is configured for implementing a plurality of classical algorithms wherein the generating of the intermediary test data is further based on the implementing of the plurality of classical algorithms, wherein the method further comprises generating, using the processing device, a plurality of updated classical algorithms using the classifier module based on the evaluating of the perturbed test data, wherein the generating of the intermediary test data is further based on the implementing of the plurality of updated classical algorithms.

10. The method of claim 3 further comprises:
receiving, using the communication device, the client-based test data from the client device; and
processing, using the processing device, the client-based test data, wherein the generating of the perturbed test data is further based on the processing of the client-based test data.

11. A method of facilitating an adversarial testing of an artificial intelligence (AI) model, the method comprising:
retrieving, using a storage device, an initial test data associated with the AI model;
analyzing, using a processing device, the initial test data;
obtaining, using the processing device, a workflow specification data representing a workflow specification associated with an adversarial workflow;
identifying, using the processing device, the adversarial workflow from a plurality of adversarial workflows using an automation module based on the workflow specification, wherein the identifying of the adversarial workflow is further based on a workflow identification technique;
determining, using the processing device, a strategic adversarial attribute relative to the initial test data using a quantum optimization module based on the analyzing of the initial test data, wherein the strategic adversarial attribute represents a strategic data-point associated with the initial test data;
generating, using the processing device, a perturbed test data using a quantum adversarial generator module based on each of the identifying of the adversarial workflow and the determining of the strategic adversarial attribute; and
transmitting, using a communication device, the perturbed test data to a client device associated with a client.

12. A system of facilitating an adversarial testing of an artificial intelligence (AI) model, the system comprising:
a storage device configured for retrieving an initial test data associated with the AI model;
a processing device communicatively coupled with the storage device, wherein the processing device is configured for generating a perturbed test data using a quantum adversarial generator module based on the initial test data; and
a communication device communicatively coupled with the processing device, wherein the communication device is configured for transmitting the perturbed test data to a client device associated with a client.

13. The system of claim 12, wherein the processing device is further configured for:
analyzing the initial test data; and
determining a strategic adversarial attribute relative to the initial test data using a quantum optimization module based on the analyzing of the initial test data, wherein the strategic adversarial attribute represents a strategic data-point associated with the initial test data, wherein the generating of the perturbed test data is further based on the determining of the strategic adversarial attribute.

14. The system of claim 12, wherein the communication device is further configured for receiving a test request data from the client device, wherein the processing device is further configured for:
analyzing the test request data; and
generating the initial test data using a classical adversarial generator module based on the analyzing of the test request data, wherein the storage device is further configured for storing the initial test data.

15. The system of claim 14, wherein the processing device is further configured for:
generating an intermediary test data using the classical adversarial generator module based on the initial test data; and
processing the intermediary test data using the quantum adversarial generator module, wherein the generating of the perturbed test data is further based on the processing of the intermediary test data.

16. The system of claim 13, wherein the generating of the perturbed test data is associated with a first time period, wherein the communication device is further configured for:
receiving a model response data from the client device, wherein the model response data represents a response associated with the AI model relative to the adversarial testing; and
transmitting a second perturbed test data to the client device, wherein the processing device is further configured for:
evaluating the model response data; and
generating the second perturbed test data using the quantum adversarial generator module based on the evaluating of the model response data, wherein the second perturbed test data represents the initial test data perturbed at a second time period, wherein the second time period occurs later than the first time period.

17. The system of claim 16, wherein the processing device is further configured for:
processing the perturbed test data;
performing an adversarial test operation on the AI model based on the processing of the perturbed test data;
obtaining a result data based on the performing of the adversarial test operation on the AI model;
evaluating the result data; and
generating an analysis report data based on the evaluating of the result data, wherein the communication device is further configured for:
transmitting the analysis report data to an external operational governance platform device associated with an external operational governance platform via a secure integration channel; and
transmitting the analysis report data to the client device.

18. The system of claim 17, wherein the processing device is further configured for:
obtaining a representation data based on the performing of the adversarial test operation, wherein the representation data represents an intermediate representation of the perturbed test data relative to the adversarial testing of the AI model;
processing the representation data;
generating a quantum-compatible representation data using the quantum optimization module based on the processing of the representation data, wherein the quantum-compatible representation data represents a representation compatible with an external quantum processing unit; and
analyzing a quantum analysis data, wherein the generating of the second perturbed test data is further based on the analyzing of the quantum analysis data, wherein each of the perturbed test data and the second perturbed test data is optimized for compatibility with each of at least one existing adversarial test operation and at least one emerging adversarial test operation, wherein the communication device is further configured for:
transmitting the quantum compatible representation data to a quantum processing device associated with the external quantum processing unit; and
receiving the quantum analysis data from the quantum processing device, wherein the quantum analysis data represents a quantum analysis relative to the representation.

19. The system of claim 15, wherein the quantum adversarial generator module is configured for implementing a plurality of quantum algorithms wherein the generating of the perturbed test data is further based on the implementing of the plurality of quantum algorithms, wherein the processing device is further configured for:
evaluating the perturbed test data using a classifier module; and
generating a plurality of updated quantum algorithms using the classifier module based on the evaluating of the perturbed test data, wherein the generating of the perturbed test data is further based on the implementing of the plurality of updated quantum algorithms.

20. The system of claim 19, wherein the classical adversarial generator module is configured for implementing a plurality of classical algorithms wherein the generating of the intermediary test data is further based on the implementing of the plurality of classical algorithms, wherein the processing device is further configured for generating a plurality of updated classical algorithms using the classifier module based on the evaluating of the perturbed test data, wherein the generating of the intermediary test data is further based on the implementing of the plurality of updated classical algorithms.
